(19) United States
(12) Patent Application Publication
(10) Pub. No.: US 2009/0258640 A1
(43) Pub. Date: Oct. 15, 2009

(54) DEVICE POWER DETECTOR

(75) Inventors: Jonas PERSSON, Furulund (SE); Bo BERNHARDSSON, Lund (SE); Robert CARLZEN, Lund (SE); Magnus NILSSON, Lund (SE); Robert NILSSON, Lund (SE)

Correspondence Address: HARRITY & HARRITY, LLP, 11350 RANDOM HILLS RD., SUITE 600, FAIRFAX, VA, 22030, US

(73) Assignee: TELEFONAKTIEBOLAGET LM ERICSSON, Stockholm (SE)

(21) Appl. No.: 12/211,927

(22) Filed: Sep. 17, 2008

Related U.S. Application Data
(60) Provisional application No. 61/044,211, filed on Apr. 11, 2008.

(51) Int. Cl. H04W 24/00; H04B 1/04

(52) U.S. Cl. 455/425; 455/127.2; 455/114.3

(57) ABSTRACT

A communication device includes a transmitter configured to provide a transmitted output signal, and a power detector configured to receive reference signals from a waveform generator associated with the transmitter, and to receive a portion of the transmitted output signal from the transmitter. The power detector is further configured to compare the reference signals with a digital representation of the portion of the transmitted output signal, and calculate a gain associated with the transmitter based on the comparison. The power detector is also configured to receive, from the waveform generator, a root mean square (RMS) value of the reference signals, and generate an estimate of the output power of the transmitter based on the calculated gain and the root mean square (RMS) value of the reference signals.

### RELATED APPLICATIONS

This application claims priority under 35 U.S.C. §119 based on U.S. Provisional Patent Application No. 61/044,211, filed Apr. 11, 2008, the entire contents of which are hereby incorporated by reference.

### TECHNICAL FIELD

Embodiments described herein relate generally to communication devices, and, more particularly, to estimating power output by a power amplifier to an antenna of a communication device.

### BACKGROUND

Third generation (3G) mobile telephony includes several different standards, such as the Code Division Multiple Access (CDMA) 2000 standard and the Universal Mobile Telecommunications System (UMTS) standard. UMTS was developed by the 3rd Generation Partnership Project (3GPP) and its radio interface is implemented with a technology called Wideband Code Division Multiple Access (W-CDMA). In W-CDMA and other 3G radio interfaces, Frequency Division Multiple Access (FDMA) and Time Division Multiple Access (TDMA) have been replaced by a spread spectrum technique where many transmitters in a cell occupy the same radio band at the same time and have to be separated by their unique spreading code.

Since many W-CDMA user devices (e.g., communication devices, such as mobile telephones) in a same cell send their upload data simultaneously and in a same band, their radio signals mix at a base station antenna. In order to distinguish each signal from the others, every sent bit is multiplied with a unique spreading code vector. Each spreading code is ideally orthogonal to all other spreading codes in use. A receiving user device can recover an original signal by using the same spreading code as a transmitting user device. However, using orthogonal codes is impractical since the codes are only orthogonal when completely in phase, which is unlikely because a distance between a base station and different user devices varies. Instead, pseudo random sequences (e.g., PN-codes) are used, and are approximately uncorrelated to each other, independent of time delay.

Using the spreading code to distinguish one specific source from a received signal is possible but the signals sent by other user devices in the same cell cannot be completely filtered out by the receiving user device. The power leaking between channels, due to imperfect coding, acts as interference and is a significant contributor to Signal-to-Interference Ratio (SIR). Signals received from user devices transmitting in a vicinity of a base station are received at a high power (e.g., by the base station), while signals received from more remote user devices are faded and weak. The SIR for the different signals is uneven and causes a bit error rate (BER). This is commonly referred to as a Near-Far problem and can be avoided by having the base station send Transmit Power Control (TPC) messages to the user devices. The 3GPP standard for W-CDMA requires a user device to track TPC-messages with a specified accuracy.

The user device acts according to TPC commands by changing amplification settings for components in a transmit chain. It is, however, very difficult to predict exactly what affect a change of settings will have on the actual output power since biasing of a transmitter (e.g., a power amplifier) will be changed to increase efficiency. One solution is to control output power with negative feedback, which requires a signal that is proportional to the output power. For example, a small portion of the signal intended for the antenna may be diverted to a power detector. The output from the power detector can be used in the power control process.

To set output power according to TPC messages, an algorithm called a power control algorithm may be used in user devices. The algorithm works in both an open loop (e.g., where the output power is estimated from look-up tables and from various environmental readings) and in a closed loop (e.g., where feedback from the power detector is used).

According to the power control algorithm, the power is controlled in a closed loop mode when output power is between a specified range (e.g., between “24” and “0” decibels of measured power per one milliwatt (dBm)), and is controlled in an open loop mode. The reason for not using closed loop control over the entire output power span is that power detectors have limited dynamic ranges.

Early implementations of W-CDMA transmitters used an external power detector at an output of a power amplifier to make continuous and gradually improved estimations of the output power. The external power detector was of the peak detector type and functioned like an amplitude modulation (AM) demodulator. In such power detectors, a radio frequency (RF) signal may be rectified and low pass filtered. This may be accomplished using, for example, a diode and an RC (resistive/capacitive) lowpass filter.

The main drawback of such an arrangement is that the power detector output is proportional to a square of a peak value of a measured signal and is not a mean of the squared signal. To translate the power detector output to an accurate power reading, different peak-to-average ratios of the signals must be compensated for by using a large number of look up values. Recent modulation schemes for high data rates have so many different peak-to-average ratio values that compensation look-up tables would occupy large amounts of memory, making the compensation problematic. The power detector is intended to measure the power sent to the antenna by the transmitter, but signals picked up by the antenna may leak back to the power detector and may cause an over-estimation of the power. Another problem is that in order to evaluate the power accurately, the power detector may need to low pass filter peaks of a detected signal. Since a resulting representation of a RF envelope (e.g., information in a signal may be referred to as the “envelope” of the signal) may need to include a low ripple, a filter cutoff frequency may be low (e.g., <“10” kHz) and a stabilization time may be long. Furthermore, such power detectors are expensive, discrete component that occupy valuable space (e.g., printed circuit board space) in the user device.

To overcome the need for modulation compensation, it has been proposed to use an external true Root Mean Square (RMS) power detector in user devices. An external true RMS detector may use analog circuits that square the RF signal and then filter the squared RF signal to obtain the power. However, such power detectors would still experience some of the disadvantages and/or problems described above. For example, the power detector would occupy valuable printed circuit board space in the user device, would be slow to converge, would be expensive, and would be susceptible to interference from neighboring channels received by the antenna.

### SUMMARY

It is an object of the invention to overcome at least some of the above disadvantages and to provide a power detector that estimates power output by a power amplifier to an antenna of a communication device.

Embodiments described herein may include systems and/or methods that provide a power detector that estimates power output by a transmitter (e.g., a power amplifier) to an antenna of a communication device (e.g., a mobile telephone, a personal digital assistant (PDA), etc.). For example, in one embodiment, the systems and/or methods may provide a power detector that may be used to estimate the actual power output by the power amplifier to the antenna. The power detector may include an analog part and a digital part. The analog part of the power detector may form a quadrature demodulator that may transform a radio signal into analog baseband (BB) signals. The power detector may sample the resulting analog baseband signals at a sample rate less than two times the information bandwidth associated with the analog baseband signals. The information bandwidth associated with the analog baseband signals may have approximately the same information bandwidth as modulation signals. Due to aliasing (or folding), this may prohibit direct calculation of the RMS value (e.g., in units of current, voltage, or electric charge) by the power detector. Instead, the digital part of the power detector may utilize signals from a waveform generator of the transmitter as a reference to determine an amplification (or gain) in the transmitter, which may be used to determine the output power of the transmitter. The digital part of the power detector may apply a time alignment process (e.g., that includes a least mean square method of correlation) to the two signals (e.g., the sampled signal from the power amplifier and the reference signal from the waveform generator).

The term “RMS value,” as used herein, may include any type of unit of measure, such as voltage, current, electrical charge, etc.

In one embodiment, the systems and/or methods described herein may provide a power detector that may be used as feedback in a control loop for the output power at the antenna. Unlike current power detectors, which occupy valuable printed circuit board space in the user device, are slow to converge, are expensive, and are susceptible to interference from neighboring channels received by the antenna, the embodiments described herein may provide a power detector that eliminates the need for an external power detector, saves valuable space in the user device, is quick to converge, is inexpensive, and is not susceptible to interference from neighboring channels received by the antenna.

In an exemplary embodiment, systems and/or methods described herein may provide a user device that includes an antenna, a transmitter providing output signal to the antenna, and a power detector. The power detector may receive reference signals from the waveform generator associated with the transmitter, may receive a portion of the transmitted output signal, and may convert the output signal to a digital representation (e.g., in an analog-to-digital converter) with a sample rate less than two times the information bandwidth associated with modulation signals. The power detector may compare the reference signals with the digital representation of the portion of the transmitted output signal to calculate a gain associated with the transmitter, and may receive a RMS value (e.g., in units of current, voltage, or electric charge) of the reference signals. The power detector may estimate the output power of the transmitter based on the calculated gain and the RMS value associated with the waveform generator's modulation signal output.

### BRIEF DESCRIPTION OF THE DRAWINGS

FIG. 1 depicts a diagram of an exemplary network in which systems and methods described herein may be implemented;

FIGS. 2A and 2B illustrate exemplary components of a user device of the network depicted in FIG. 1;

FIG. 3 depicts further exemplary components of the user device of the network illustrated in FIG. 1;

FIG. 4 illustrates exemplary components of a transmitter of the user device depicted in FIG. 3;

FIG. 5 depicts exemplary components of a power detector of the user device illustrated in FIG. 3;

FIG. 6 illustrates exemplary functional components of a power estimator of the power detector depicted in FIG. 5; and

FIGS. 7-10 depict flow charts of an exemplary process according to embodiments described herein.

### DETAILED DESCRIPTION

The following detailed description refers to the accompanying drawings. The same reference numbers in different drawings may identify the same or similar elements. Also, the following detailed description does not limit the invention.

Embodiments described herein may include systems and/or methods that provide a power detector that estimates power output by a transmitter (e.g., a power amplifier) to an antenna of a communication device (e.g., a mobile telephone, a personal digital assistant (PDA), etc.).

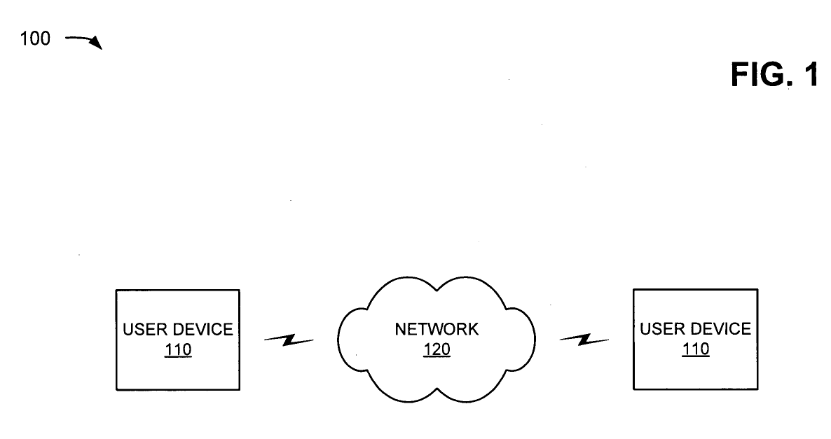

FIG. 1 is a diagram of an exemplary network 100 in which systems and methods described herein may be implemented. As illustrated, network 100 may include user devices 110 interconnected by a network 120. Components of network 100 may interconnect via wired and/or wireless connections. Two user devices and a single network have been illustrated in FIG. 1 for simplicity. In practice, there may be more user devices and/or networks. Also, in some instances, one or more of the components of network 100 may perform one or more functions described as being performed by another one or more of the components of network 100.

Each of user devices 110 may include a communication device (e.g., a radiotelephone, a personal communications system (PCS) terminal that may combine a cellular radiotelephone with data processing and data communications capabilities, a PDA that can include a radiotelephone, a pager, Internet/intranet access, etc.), a lap top, a personal computer, or other types of computation or communication devices, threads or processes running on these devices, and/or objects executable by these devices. In one embodiment, each of user devices 110 may include a communication device with a transmitter (e.g., a power amplifier) capable of providing output power to an antenna.

Network 120 may include a local area network (LAN), a wide area network (WAN), a metropolitan area network (MAN), a Public Land Mobile Network (PLMN), a telephone network, such as the Public Switched Telephone Network (PSTN), a cellular telephone network, an intranet, the Internet, or a combination of networks. In one exemplary embodiment, network 120 may include a radio access network with one or more devices (e.g., base stations, radio network controllers, etc.) for transmitting voice and/or data to user devices 110. The radio access network may include, for example, a CDMA 2000-based network, a UMTS-based network, a W-CDMA based network, a FDMA-based network, a TDMA-based network, a Global System for Mobile Communications (GSM) network, a PCS-based network, a Long Term Evolution (LTE)-based network, other third generation (3G) cellular networks, other second generation (2G) cellular networks, etc.

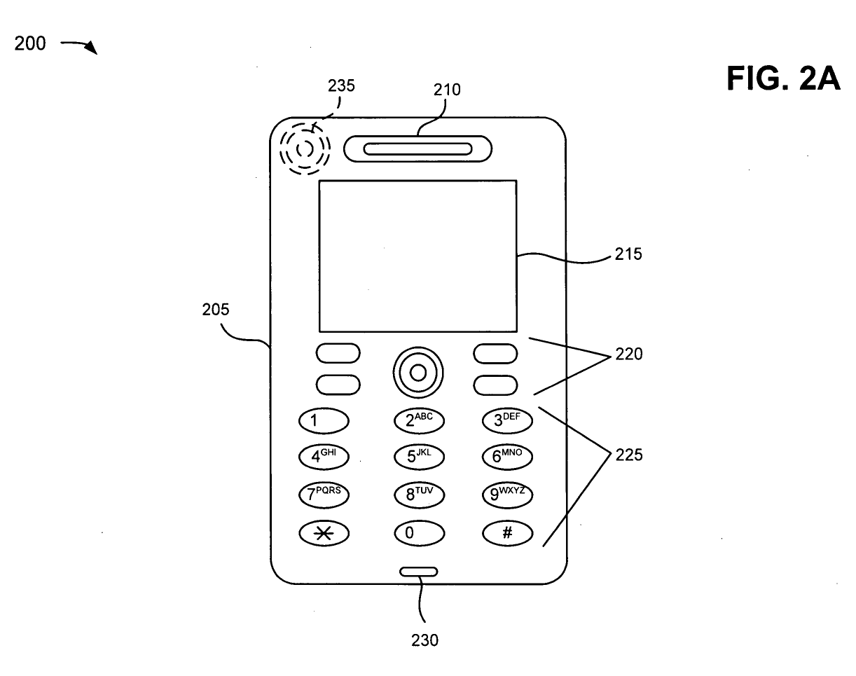

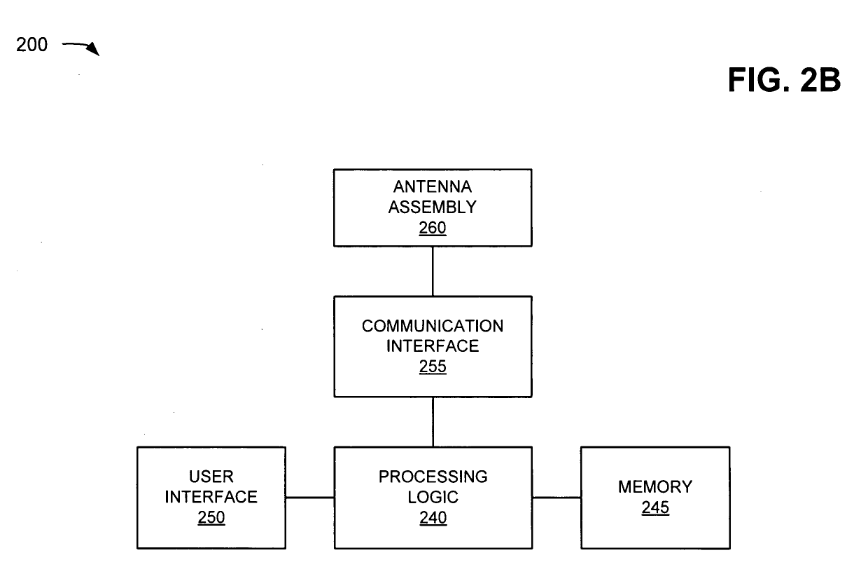

FIGS. 2A and 2B illustrate exemplary components of a device 200 that may correspond to one of user devices 110. As illustrated in FIG. 2A, device 200 may include a housing 205, a speaker 210, a display 215, control buttons 220, a keypad 225, a microphone 230, and/or a camera 235. Housing 205 may protect the components of device 200 from outside elements. Speaker 210 may provide audible information to a user of device 200. Display 215 may provide visual information to the user. Control buttons 220 may permit the user to interact with device 200 to cause device 200 to perform one or more operations. Keypad 225 may include a standard telephone keypad. Microphone 230 may receive audible information from the user. Camera 235 may enable device 200 to capture and/or store video and/or images (e.g., pictures).

As illustrated in FIG. 2B, device 200 may further include processing logic 240, a memory 245, a user interface 250, a communication interface 255, and/or an antenna assembly 260.

Processing logic 240 may include a processor, a microprocessor, an application specific integrated circuit (ASIC), a field programmable gate array (FPGA), or the like. Processing logic 240 may control operation of device 200 and its components. In one embodiment, processing logic 240 may control operation of components of device 200 in a manner described herein.

Memory 245 may include a random access memory (RAM), a read-only memory (ROM), and/or another type of memory to store data and instructions that may be used by processing logic 240.

User interface 250 may include mechanisms for inputting information to device 200 and/or for outputting information from device 200.

Communication interface 255 may include, for example, a transmitter that may convert baseband signals from processing logic 240 to radio frequency (RF) signals and/or a receiver that may convert RF signals to baseband signals. Alternatively, communication interface 255 may include a transceiver to perform functions of both a transmitter and a receiver. Communication interface 255 may connect to antenna assembly 260 for transmission and/or reception of the RF signals.

Antenna assembly 260 may include one or more antennas to transmit and/or receive signals over the air. Antenna assembly 260 may, for example, receive RF signals from communication interface 255 and transmit them over the air, and receive RF signals over the air and provide them to communication interface 255. In one embodiment, for example, communication interface 255 may communicate with a network (e.g., network 100) and/or devices connected to a network.

As described herein, device 200 may perform certain operations in response to processing logic 240 executing software instructions of an application contained in a computer-readable medium, such as memory 245. A computer-readable medium may be defined as a physical or logical memory device. The software instructions may be read into memory 245 from another computer-readable medium or from another device via communication interface 255. The software instructions contained in memory 245 may cause processing logic 240 to perform processes that described herein. Alternatively, hardwired circuitry may be used in place of or in combination with software instructions to implement processes described herein. Thus, embodiments described herein are not limited to any specific combination of hardware circuitry and software.

Although FIGS. 2A and 2B show exemplary components of device 200, in other embodiments, device 200 may contain fewer, different, or additional components than depicted in FIGS. 2A and 2B. In still other embodiments, one or more components of device 200 may perform one or more tasks described as being performed by one or more other components of device 200.

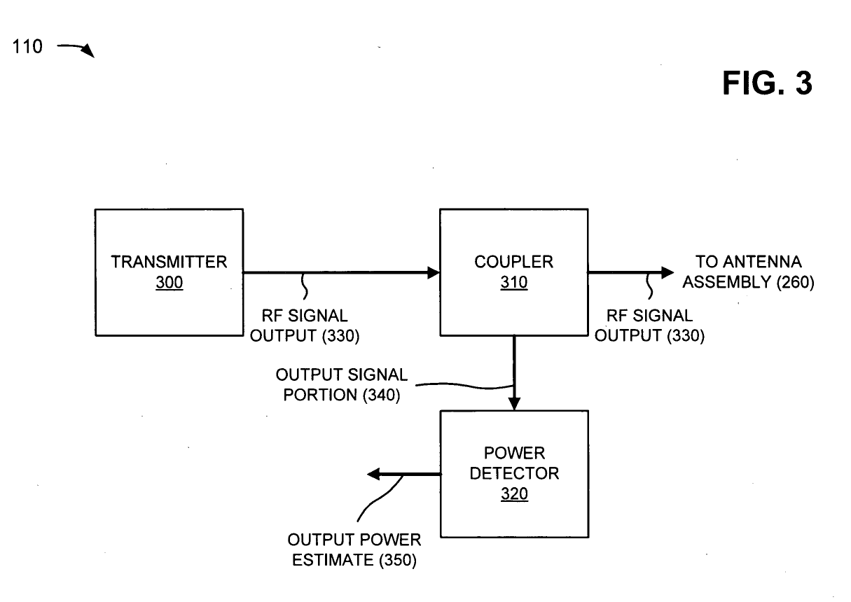

FIG. 3 depicts further exemplary components of user device 110. As illustrated, user device 110 may include a transmitter 300, a coupler 310, and a power detector 320.

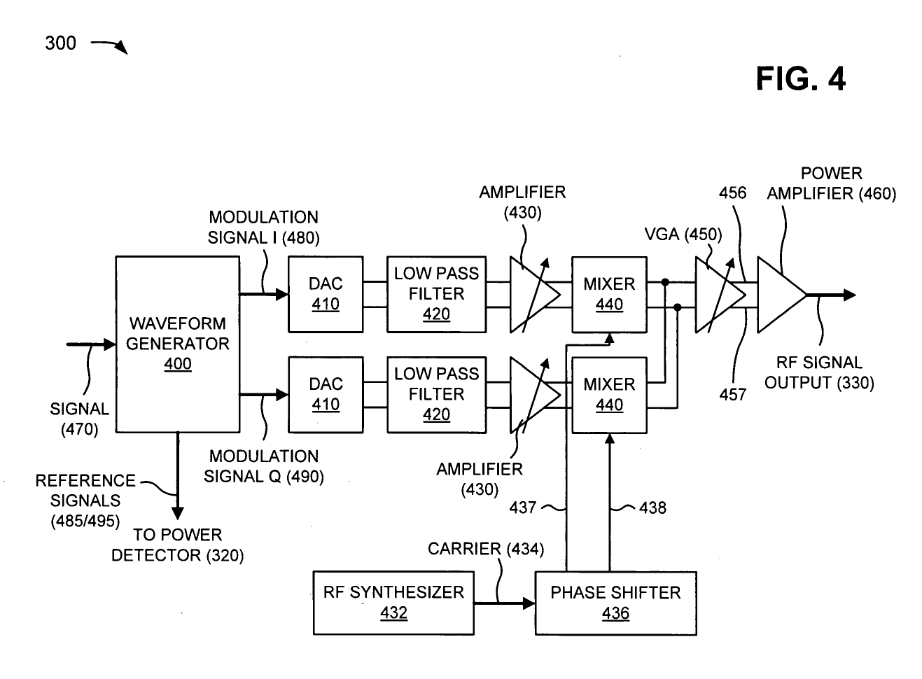

Transmitter 300 may include a device that may convert baseband signals (e.g., from processing logic 240) to RF signals, a device that may convert RF signals to baseband signals, a device that may perform both of the aforementioned functions, etc. In one exemplary embodiment, transmitter may provide a RF signal output 330 to antenna assembly 260 and to coupler 310. Further details of transmitter 300 are provided below in connection with, for example, FIG. 4.

Coupler 310 may include a device that receives RF signal output 330 from transmitter 300, and couples a portion of RF signal output 330 to power detector 320. In one exemplary embodiment, coupler 310 may include a directional coupler that couples a portion of RF signal output 330 (e.g., output signal portion 340) through a port by using two transmission lines set close enough together such that energy passing through one line is coupled to the other line.

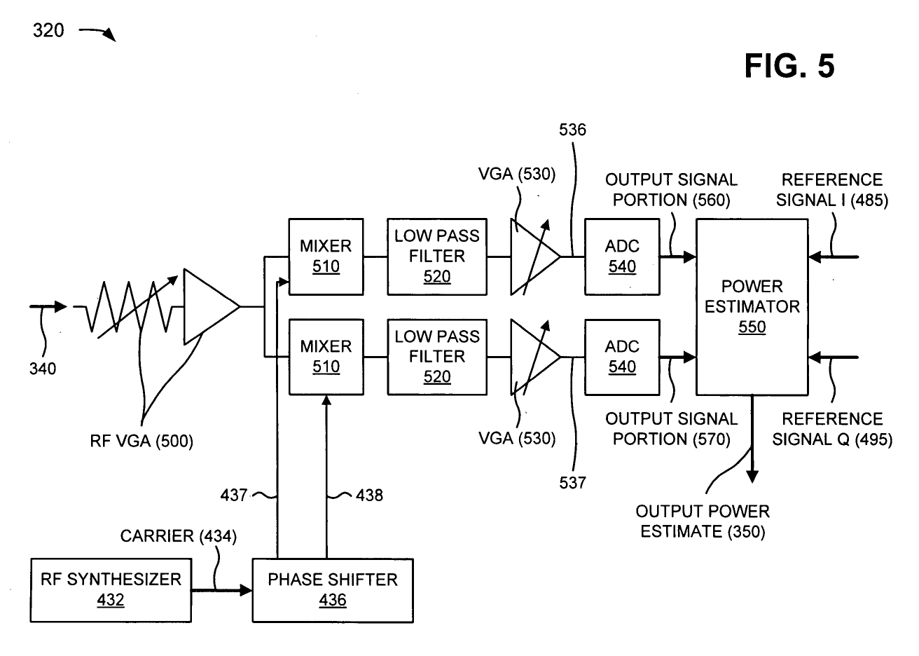

Power detector 320 may include a device that receives output signal portion 340, and calculates an estimate 350 of power output by transmitter 300 (e.g., estimates RF signal output 330) to antenna assembly 260. For example, in one embodiment, power detector 320 may include an analog part and a digital part. The analog part of power detector 320 may form a quadrature demodulator that may transform a radio signal into baseband (BB) signals. Power detector 320 may sample these analog baseband signals at a sample rate less than two times the information bandwidth associated with the analog baseband signals. The information bandwidth associated with the analog baseband signals may have approximately the same information bandwidth as modulation signals. The digital part of power detector 320 may utilize output from a waveform generator of transmitter 300 as a reference to determine an amplification (or gain) in transmitter 300, which may be used to determine an output power estimate 350 associated with transmitter 300. The digital part of power detector 320 may apply a time alignment process (e.g., that includes a least mean square method of correlation) to the two signals (e.g., the envelope of the down-converted and sampled BB signals attained from a portion of the transmitted RF output signal and the envelope of the reference signals from the waveform generator). Further details of power detector 320 are provided below in connection with, for example, FIG. 5.

Although FIG. 3 shows exemplary components of user device 110, in other embodiments, user device 110 may contain fewer, different, or additional components than depicted in FIG. 3. In still other embodiments, one or more components of user device 110 may perform one or more tasks described as being performed by one or more other components of user device 110.

FIG. 4 illustrates exemplary components of transmitter 300 of user device 110. As depicted, transmitter 300 may include a waveform generator 400, digital-to-analog converters (DACs) 410, low pass filters 420, amplifiers 430, a RF synthesizer 432, a phase shifter 436, mixers 440, a variable gain amplifier (VGA) 450, and a power amplifier 460.

Waveform generator 400 may include a device that receives a signal 470 (e.g., an outgoing signal to be transmitted by user device 110), and transforms signal 470 into a first modulation (I) signal 480 and a second modulation (Q) signal 490, and also into a first reference signal 485 and a second reference signal 495. Modulation signals 480/490 may include waveforms (e.g., Cartesian representations of signal 470) that may be used to modulate a carrier signal (e.g., carrier signal 434). In one embodiment, waveform generator 400 may use a modulation method called Quadrature Phase Shift Key (QPSK). QPSK may modulate both phase and amplitude of a RF carrier signal (e.g., carrier signal 434). The two modulation signals, I and Q, may represent the real and imaginary parts of a complex signal (e.g., signal 470). In quadrature modulation, the signals, I and Q, may be modified independently of the complex signal, and a value of the complex signal may be translated into a symbol. Modulation signals 480/490 may arrive at power amplifier 460 after up-conversion (in mixers 440) as RF signals 456/457. As further shown in FIG. 4, waveform generator 400 may provide reference signals 485/495 to power detector 320.

Each of DACs 410 may include a device that converts a digital (e.g., binary) code to an analog signal (e.g., to a current, voltage, or electric charge). In one embodiment, each of DACs 410 may receive corresponding modulation signals 480/490 from waveform generator 400, and may convert modulation signals 480/490 from digital signals into analog signals. DACs 410 may provide the converted modulation signals 480/490 to corresponding low pass filters 420.

Each of low pass filters 420 may include a filter that passes low-frequency signals but attenuates (e.g., reduces an amplitude of) signals with frequencies higher than a cutoff frequency. In one embodiment, each of low pass filters 420 may receive the converted modulation signals 480/490 from corresponding DACs 410, and may attenuate (or amplify) the converted modulation signals 480/490. Low pass filters 420 may provide the attenuated (or amplified), converted modulation signals 480/490 to corresponding amplifiers 430.

Each of amplifiers 430 may include a device that converts a voltage to a proportional current, and amplifies (or increases) the result. In one embodiment, each of amplifiers 430 may receive the attenuated (or amplified), converted modulation signals 480/490 from corresponding low pass filters 420, and may amplify the results (e.g., to a level suitable for mixers 440). Amplifiers 430 may provide the amplified results to corresponding mixers 440.

RF synthesizer 432 may include a device (e.g., a local oscillator, a phased locked loop (PLL), etc.) that generates a RF carrier signal (e.g., carrier signal 434), and provides carrier signal 434 to phase shifter 436.

Phase shifter 436 may include a device that receives carrier signal 434 from RF synthesizer 432, and shifts a phase of carrier signal 434. In one embodiment, phase shifter 436 may provide a first phase carrier signal 437 to one of mixers 440, and may provide a second phase carrier signal 438 to the other mixer 440.

Each of mixers 440 may convert baseband signals to radio frequency signals. In one embodiment, each of mixers 440 may receive the amplified results from corresponding amplifiers 430 and first/second phase carrier signals 437/438 from phase shifter 436, may mix the signals, and may convert the mixed signals to radio frequency signals. Mixers 440 may provide the radio frequency signals to variable gain amplifier (VGA) 450.

VGA 450 may include an electronic amplifier that varies its gain depending on a control voltage. In one embodiment, VGA 450 may receive the radio frequency signals from mixers 440, may vary a gain of the radio frequency signals, and may provide the resulting radio frequency signals (e.g., RF signals 456/457) to power amplifier 460. Radio frequency signals input to VGA 450 (e.g., from mixers 440) may include a differential signal (e.g., as shown in FIG. 4) or a single-ended signal.

Power amplifier 460 may include a device that changes (e.g., increases) an amplitude of a signal. In one embodiment, power amplifier 460 may receive the resulting RF signals (e.g., RF signals 456/457) from VGA 450, may amplify (or increase) amplitudes of the resulting RF signals, and may output the amplified resulting RF signals as RF signal output 330. RF signals 456/457 may include a differential signal (e.g., as shown in FIG. 4) or a single-ended signal. If RF signals 456/457 are implemented as a differential signal and power amplifier 460 has a single-ended input, an additional component may be used to transform RF signals 456/457 at an output of VGA 450 to a single-ended signal at an input of power amplifier 460.

Although FIG. 4 shows exemplary components of transmitter 300, in other embodiments, transmitter 300 may contain fewer, different, or additional components than depicted in FIG. 4. In still other embodiments, one or more components of transmitter 300 may perform one or more tasks described as being performed by one or more other components of transmitter 300.

FIG. 5 depicts exemplary components of power detector 320 of user device 110. As illustrated, power detector 320 may include a RF VGA 500, mixers 510, low pass filters 520, VGAs 530, analog-to-digital converters (ADCs) 540, and a power estimator 550.

RF VGA 500 may include a device that isolates and impedance matches power detector 320 and transmitter 300, and buffers a signal (e.g., output signal portion 340) provided to mixers 510. In one embodiment, RF VGA 500 may receive output signal portion 340 from coupler 310.

Each of mixers 510 may convert a radio frequency signal (e.g., a combination of output signal portion 340 and first/second phase carrier signals 437/438) to a baseband signal. In one embodiment, each of mixers 510 may receive output signal portion 340 from RF VGA 500 and first/second phase carrier signals 437/438 from phase shifter 436, may mix the signals, and may convert the mixed signals to baseband signals. Mixers 510 may provide the baseband signals to corresponding low pass filters 520.

Each of low pass filters 520 may include a filter that passes low-frequency signals but attenuates (e.g., reduces an amplitude of) signals with frequencies higher than a cutoff frequency. In one embodiment, each of low pass filters 520 may receive the baseband signals from corresponding mixers 510, and may attenuate (or amplify) the baseband signals. Low pass filters 520 may provide the attenuated (or amplified) baseband signals to corresponding VGAs 530. In one embodiment, phase shifter 436, mixers 510, and low pass filters 520 may form a quadrature detector.

Each of VGAs 530 may include an electronic amplifier that varies its gain depending on a control voltage. In one embodiment, each of VGAs 530 may receive the attenuated (or amplified) baseband signals from corresponding low pass filters 520, may vary a gain of the baseband signals, and may provide the resulting baseband signals to corresponding ADCs 540.

Each of ADCs 540 may include a device that converts an analog signal (e.g., a current, voltage, or electric charge) to a digital (e.g., binary) code. In one embodiment, each of ADCs 540 may receive baseband signals 536/537 from corresponding VGAs 530, and may convert the baseband signals from analog signals into digital signals. A sample rate of each ADC 540 may be less than two times (e.g., under-sampling) the information bandwidth associated with the analog baseband signals, which enables closed loop power control with relatively simple and current saving ADCs 540. Under-sampling may enable less data to be handled when performing gain calculation in power detector 320. Each of ADCs 540 may provide the converted baseband signals 560/570 to power estimator 550.

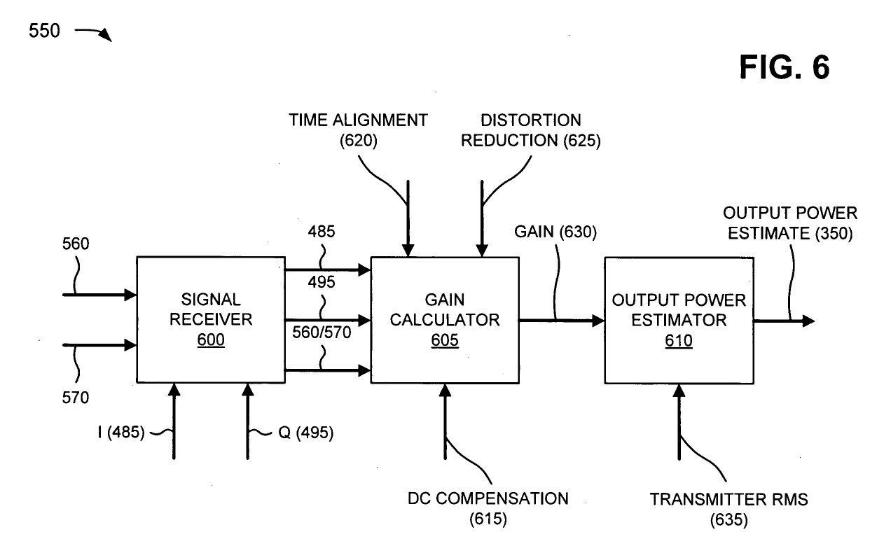

Power estimator 550 may include any hardware, software, or combination of hardware and software based logic (e.g., processing logic 240) that receives signals 560/570 from ADCs 540, receives reference signals 485/495 from waveform generator 400, and calculates output power estimate 350 (e.g., associated with transmitter 300) based on signals 560/570 and reference signals 485/495. Further details of power estimator 550 are provided below in connection with, for example, FIG. 6.

Although FIG. 5 shows exemplary components of power detector 320, in other embodiments, power detector 320 may contain fewer, different, or additional components than depicted in FIG. 5. In still other embodiments, one or more components of power detector 320 may perform one or more tasks described as being performed by one or more other components of power detector 320. For example, power detector may include a variable attenuator (or amplifier) that may be changed so that output signal portion 340 may fit within a dynamic range of ADCs 540.

FIG. 6 illustrates exemplary functional components of power estimator 550 of power detector 320. As shown, power estimator 550 may include signal receiver logic 600, gain calculator logic 605, and output power estimator logic 610.

Signal receiver logic 600 may include any hardware, software, or combination of hardware and software based logic (e.g., processing logic 240) that enables power estimator 550 to receive signals 560/570 from ADCs 540, and to receive reference signals 485/495 from waveform generator 400. Signal receiver logic 600 may provide signals 560/570 and reference signals 485/495 to gain calculator logic 605.

Gain calculator logic 605 may include any hardware, software, or combination of hardware and software based logic (e.g., processing logic 240) that receives signals 560/570 and reference signals 485/495 from signal receiver logic 600, compares signals 560/570 and reference signals 485/495, and calculates a gain 630 (e.g., associated with transmitter 300) based on signals 560/570 and reference signals 485/495. It may not be possible to directly calculate a RMS value (e.g., in units of current, voltage, or electric charge) of sparsely sampled signals (i.e., signals 560/570). References signals 485/495 may be available digitally as output from waveform generator 400. Each of reference signals 485/495 may be used by gain calculator logic 605, together with signals 560/570, to calculate gain 630. Gain calculator logic 605 may provide gain 630 to output power estimator logic 610.

Gain calculator logic 605 may calculate gain 630 in a variety of ways, such as by calculating a ratio between the envelope of signals 560/570 and the envelope of reference signals 485/495. In one example, assuming that the shape of the envelope of signals 560/570 is unchanged in all aspects except amplification, gain calculator logic 605 may divide a mean of the envelope of signals 560/570 by a mean of the envelope of reference signals 485/495. Gain calculator logic 605 may compensate this ratio for the effects of power detector 320 in order to obtain gain 630. In another example, gain calculator logic 605 may calculate a RMS value (e.g., in units of current, voltage, or electric charge) of both signal envelopes, and may divide the RMS value associated with signals 560/570 by the RMS value associated with reference signals 485/495 to calculate gain 630.

A signal (e.g., signal 470) may pass through several components of user device 110 that may affect its properties in unwanted ways. For example, noise, distortion, and time delay may be added to signal 470 via transmitter 300 and/or power detector 320. It may be important to have accurate data associated with the gain of the analog part of power detector 320 since uncertainty of the gain may translate directly to error in the output power estimate determined by power detector 320. Relative power estimates may also be sensitive to changes that occur between two sequential measurements. Variation of temperature or supply voltage may cause some parameters to change, but this may occur gradually over time and may be negligible. Calibration of low pass filters 420 may induce abrupt changes in the delay of RF signal output 330, but this function may be executed at data transfer start up. In the analog part of power detector 320, problems, such as nonlinearities, gain offsets, battery voltage ripple, and process variations may affect the signal reaching ADCs 540.

Furthermore, it is not possible to directly compare reference signals 485/495 with signals 560/570 because of a phase shift to signals 560/570 caused by a delay in power amplifier 460 and other components. A resulting rotation of an IQ chart may change signals 560/570, but the envelope may still be intact. Dividing the RMS (or mean) values (e.g., in units of current, voltage, or electric charge) of two simultaneously acquired sets of envelope data from reference signals 485/495 and signals 560/570 may not be a very accurate way to calculate gain 630 either because the RMS value of signals 560/570 may be unreliable. A ratio between the RMS values (or mean values) may be subject to the same level of uncertainty. Thus, power estimator 550 may implement various processes (e.g., via gain calculator logic 605) to address such problems before calculating gain 630.

As shown in FIG. 6, gain calculator logic 605 may implement a direct current (DC) compensation process 615, a time alignment process 620, and/or a distortion reduction process 625, before calculating gain 630.

A signal that reaches one of ADCs 540 may include a DC component (e.g., that originates from power detector 320) that may vary over time, and may need to be eliminated. DC compensation process 615 may determine an estimate of DC before executing a process to eliminate DC. For example, DC compensation process 615 may calculate a mean value of the incoming signals, and may subtract the mean value from the signals. DC compensation process 615 may use a gain of VGAs 530 to compensate the mean value for offset due to amplification, and may store the compensated mean value (e.g., in a DC buffer). DC compensation process 615 may calculate a mean value of the DC buffer, and may multiply the mean value of the DC buffer by a gain of VGAs 530. DC compensation process 615 may subtract the multiplied mean value from the incoming signals, and gain calculator logic 605 may calculate gain 630.

With a longer DC buffer, the DC estimation may be improved unless an offset variation in the incoming signals is too severe. This may make the previous mean values useless for the next DC calculation. In one embodiment, the DC buffer length may be set according to a tolerated error. The gain compensation may enable use of previously collected data if a gain step occurs.

Time alignment process 620 may be used to address the delay introduced by various components in the signal path from waveform generator 400 to power amplifier 460 and back through power detector 320. Components that introduce delay may include, for example, low pass filters 420, power amplifier 460, low pass filters 520, and ADCs 540.

Methods of aligning signals may utilize a correlation metric to determine the delay between the signal envelopes. This may be done in the frequency and/or time domains using, for example, cross correlation, and/or by calculating the least mean square for the difference between the signals for varying delays. Time alignment process 620 may test realistic delays between the signals. In one embodiment, time alignment process 620 may use cross correlation in both the time and frequency domains. Time alignment process 620 may use an equation that is an element-wise multiplication of overlapping parts of two vectors when they are slid over each other. A large product may indicate good correlation for a delay. This method may enable determination of a delay even under very noisy conditions (e.g., with distortion DC-offset and gain). In another embodiment, time alignment process 620 may subtract the overlapping segments for each delay, and a norm of the difference vector (e.g., a mean square) may be minimized where the delay is at its correct value (e.g., a least mean square method).

Time alignment process 620 may include methods with high or low precision depending on the sample-rate of reference signals 485/495. Precision may be increased by applying an interpolation method of choice to reference signals 485/495 and thereby increasing the sample-rate and the number of delay cases to be tested. In one embodiment, time alignment process 620 may include a coarse time alignment technique that down samples reference signals 485/495 to the same sample-rate as signals 560/570 (or removes samples which have no corresponding samples with signals 560/570), and uses a correlation metric for different delays. Time alignment process 620 may include a fine time alignment technique that uses a number of possible versions of reference signals 485/495 (i.e., use the reference signals as they are, etc.). With a higher sample rate of reference signals 485/495, more combinations of reference signals 485/495 and signals 560/570 may be tested for correlation.

Time alignment process 620 may include increasing the sample rate of reference signals 485/495 by interpolation. For example, if the sample rate of reference signals 485/495 is increased by a factor N (e.g., N=2), a remaining time error after alignment may be reduced by the same factor.

Distortion may cause problems when a signal is poorly represented (e.g. due to sparse sampling). Calculation of gain 630 by gain calculator logic 605 may depend on what portion of a waveform is represented by the samples. Distortion reduction process 625 may be employed by gain calculator logic 605 to address such distortion problems. Distortion reduction process 625 may include a variety of techniques, such as reducing sample collection, extending sample collection, and/or distorting reference signals 485/495. In reduced sample collection, distortion reduction process 625 may remedy imperfections introduced into calculation of gain 630 caused by nonlinearities of power amplifier 460 by modifying a sample collection spread (e.g., by removing elements where there is an over-representation). For example, if reference signals 485/495 are sampled at a certain rate, a correct RMS value (e.g., in units of current, voltage, or electric charge) may be calculated for reference signals 485/495, and a correct gain 630 may be calculated from the RMS value. Assuming that fewer samples are to be used for reference signals 485/495 and the RMS value is to be calculated, distortion reduction process 625 may modify a distribution to resemble a distribution of reference signals 485/495. To apply this in practice, distortion reduction process 625 may sort samples of reference signals 485/495 into a number (e.g., three) different baskets (or bins) according to value. After applying time alignment process 620 and down-sampling, distortion reduction process 625 may repeat the sorting of samples. Some of the samples in the down-sampled reference signals 485/495 and signals 560/570 may be removed to imitate the distribution of full resolution reference signals 485/495.

To obtain the same performance described for reduced sample collection but without removing samples, distortion reduction process 625 may employ extended sample collection. In extended sample collection, interpolation may be used for the baskets where there are too few samples to imitate the distribution of full resolution reference signals 485/495. The RMS value calculation may be more dependent on those samples that are used for linear interpolation. Extended sample collection may enable distortion reduction process 625 to handle noise, time mismatch, and phase noise.

In distorting reference signals 485/495, the sampled data may be used to create an AM/AM distortion polynomial. Reference signals 485/495 may be distorted with AM/AM distortion polynomial, and its RMS value may be compared to that of the original reference signals 485/495.

Output power estimator logic 610 may include any hardware, software, or combination of hardware and software based logic (e.g., processing logic 240) that receives gain 630 from gain calculator logic 605, and receives a RMS value 635 from transmitter 300 (e.g., a RMS value of reference signals 485/495 from waveform generator 400). Output power estimator logic 610 may determine output power estimate 350, associated with transmitter 300, based on gain 630 and RMS value 635. In one embodiment, output power estimator logic 610 may use gain 630 to scale RMS value 635, and may determine output power estimate 350 based on the scaled RMS value 635. Output power estimator logic 610 may provide output power estimate 350 to other components of user device 110 (e.g., to processing logic 240) where it may be used to control the output power generated by user device 110 (e.g., via transmitter 300).

Although FIG. 6 shows exemplary components of power estimator 550, in other embodiments, power estimator 550 may contain fewer, different, or additional components than depicted in FIG. 6. In still other embodiments, one or more components of power estimator 550 may perform one or more tasks described as being performed by one or more other components of power estimator 550.

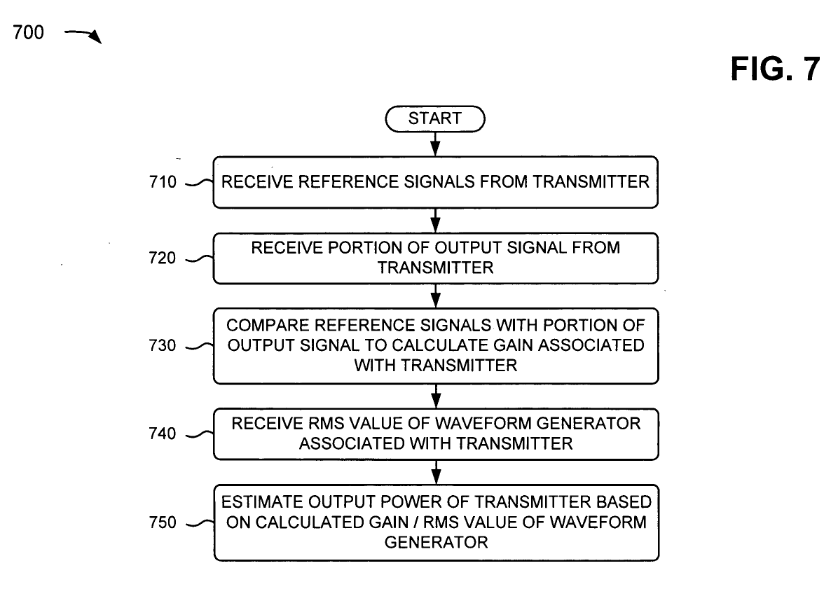

FIGS. 7-10 depict flow charts of an exemplary process 700 for estimating power output by a transmitter (e.g., power amplifier 460) to an antenna (e.g., antenna assembly 260) of user device 110 according to embodiments described herein. In one embodiment, process 700 may be performed by hardware and/or software components of user device 110 (e.g., power detector 320). In other embodiments, process 700 may be performed by hardware and/or software components of user device 110 in combination with hardware and/or software components of another device or group of devices (e.g., communicating with user device 110).

As illustrated in FIG. 7, process 700 may begin with receipt of reference signals from a transmitter (block 710), and receipt of a digital representation of a portion of output signal from the transmitter (block 720). For example, in embodiments described above in connection with FIGS. 3 and 5, power detector 320 may include a device that receives output signal portion 340 from transmitter 300. Power estimator 550 of power detector 320 may receive reference signals 485/495 from waveform generator 400 of transmitter 300.

Returning to FIG. 7, the reference signals may be compared with the digital representation of the portion of the output signal to calculate a gain associated with the transmitter (block 730). For example, in embodiments described above in connection with FIG. 6, gain calculator logic 605 of power detector 320 may receive signals 560/570 (e.g., that may correspond to output signal portion 340) and reference signals 485/495 from signal receiver logic 600, may compare signals 560/570 and reference signals 485/495, and may calculate gain 630 (e.g., associated with transmitter 300) based on signals 560/570 and reference signals 485/495.

As further shown in FIG. 7, a root mean square (RMS) value of the reference signals from a waveform generator associated with the transmitter may be received (block 740), and an output power of the transmitter may be estimated based on the calculated gain and the RMS value of the reference signals (block 750). For example, in embodiments described above in connection with FIG. 6, output power estimator logic 610 or power detector 320 may receive gain 630 from gain calculator logic 605, and may receive RMS value 635 from transmitter 300 (e.g., from waveform generator 400). Output power estimator logic 610 may determine output power estimate 350, associated with transmitter 300, based on gain 630 and RMS value 635.

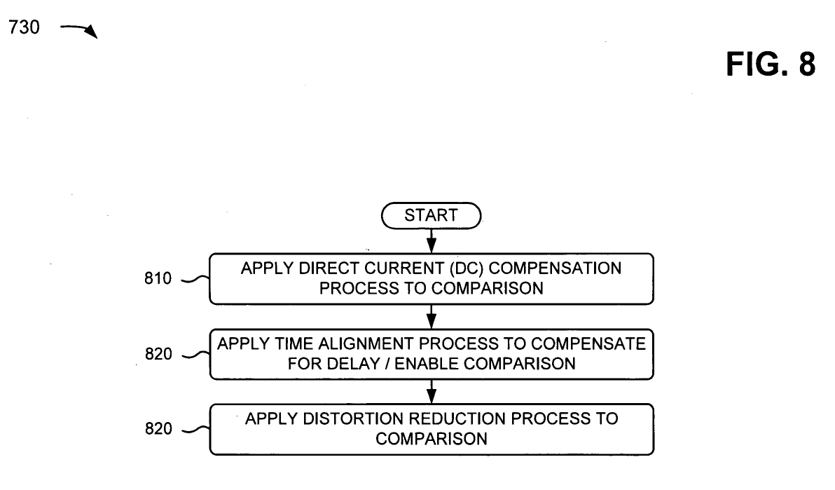

Process block 730 may include the process blocks depicted in FIG. 8. As illustrated in FIG. 8, process block 730 may include applying a direct current (DC) compensation process to the comparison (block 810). For example, in embodiments described above in connection with FIG. 6, gain calculator logic 605 of power detector 320 may implement direct current (DC) compensation process 615 before calculating gain 630.

Returning to FIG. 8, process block 730 may include applying a time alignment process to compensate for delay and to enable the comparison between reference signals and the digital representation of the portion of the output signal (block 820), and/or applying a distortion reduction process to the comparison (block 830). For example, in embodiments described above in connection with FIG. 6, gain calculator logic 605 of power detector 320 may implement time alignment process 620 before calculating gain 630, and/or may implement distortion reduction process 625 before calculating gain 630.

In one embodiment, process block 810 may include use of a correlation metric for different realistic delays between reference signals 485/495 and the digital representation of a portion of output signal 330, where different sample rates of reference signals 485/495 may be used to achieve precision. Time alignment may be performed in steps by using the lowest possible sample rate to fulfill the Nyquist criteria for reference signals 485/495, and using an interpolation method of choice to improve precision by investigating around the predetermined coarse delay.

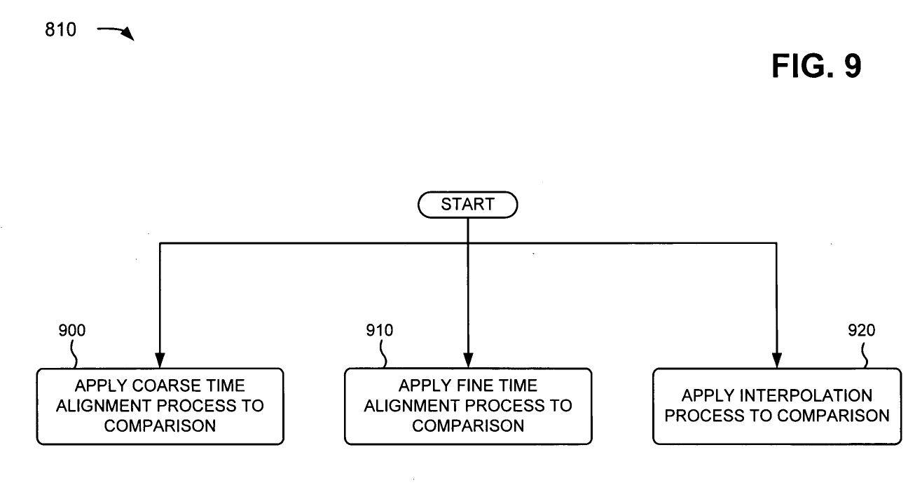

Process block 810 may include the process blocks depicted in FIG. 9. As illustrated in FIG. 9, process block 810 may include applying a coarse time alignment process to the comparison (block 900). For example, in embodiments described above in connection with FIG. 6, time alignment process 620 may be used to address the delay introduced by various components in the signal path from waveform generator 400 to power amplifier 460 and back through power detector 320. Time alignment process 620 may use cross correlation in both the time and frequency domains. Time alignment process 620 may include a coarse time alignment technique that down samples reference signals 485/495 to the same sample-rate as signals 560/570, and uses a correlation metric for different delays.

Returning to FIG. 9, process block 810 may include applying a fine time alignment process to the comparison (block 910), or applying an interpolation process to the comparison (block 920). For example, in embodiments described above in connection with FIG. 6, time alignment process 620 may include a fine time alignment technique that uses a number of possible versions of reference signals 485/495 (i.e., use the reference signals as they are, etc.). Time alignment process 620 may increase a sample rate of reference signals 485/495 by interpolation.

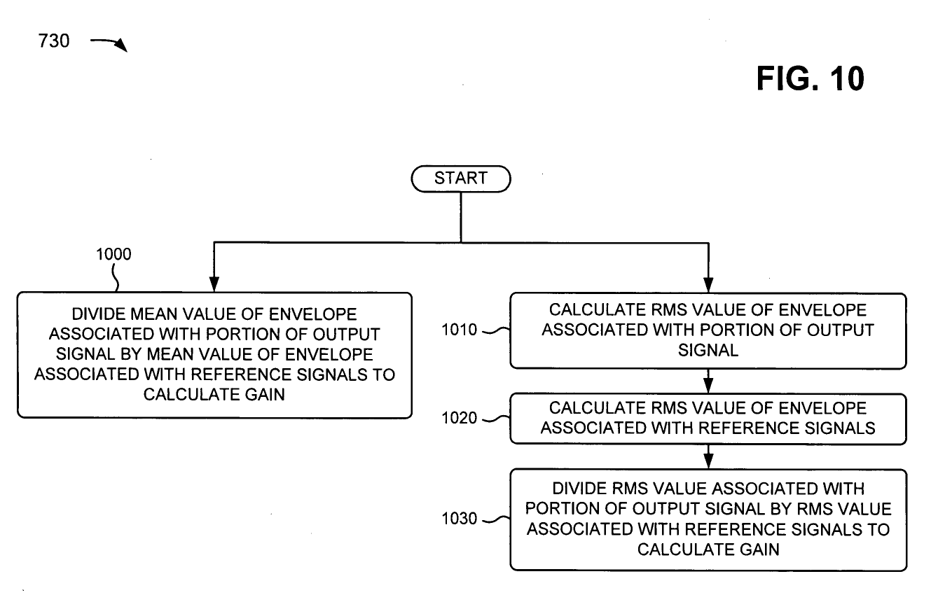

Alternatively and/or additionally, process block 730 may include the process blocks depicted in FIG. 10. As illustrated in FIG. 10, process block 730 may include dividing a mean of an envelope associated with the portion of the output signal by a mean of an envelope associated with the reference signals to calculate the gain (block 1000), and/or calculating a RMS value of the envelope associated with the portion of the output signal (block 1010), calculating a RMS value of the envelope associated with the reference signal (block 1020), and dividing the RMS value associated with the portion of the output signal by the RMS value associated with the reference signals to calculate the gain (block 1030). For example, in embodiments described above in connection with FIG. 6, gain calculator logic 605 of power detector 320 may calculate gain 630 in a variety of ways. In one example, assuming that the shape of the envelope of signals 560/570 is unchanged in all aspects except amplification, gain calculator logic 605 may divide a mean of the envelope of signals 560/570 by a mean of the envelope of reference signals 485/495. Gain calculator logic 605 may compensate this ratio for the effects of power detector 320 in order to obtain gain 630. In another example, gain calculator logic 605 may calculate a RMS value (e.g., in units of current, voltage, or electric charge) of both signal envelopes, and may divide the RMS value associated with signals 560/570 by the RMS value associated with reference signals 485/495 to calculate gain 630.

Embodiments described herein may include systems and/or methods that provide a power detector that estimates power output by a transmitter (e.g., a power amplifier) to an antenna of a communication device (e.g., a mobile telephone, a personal digital assistant (PDA), etc.). The estimated power output may be provided to other components of the communication device 110 where it may be used to control the output power generated by the communication device.

Embodiments described herein may provide a variety of advantages. For example, embodiments described herein may provide a power detector that eliminates the need for an external power detector, saves valuable space in a user device (e.g., user device 110), is quick to converge, is inexpensive, and is not susceptible to interference from neighboring channels received by an antenna of the user device. Embodiments described herein may assure modulation independence by using a waveform generator signal as a reference signal in order to estimate the power output by the transmitter to an antenna of a communication device. Furthermore, embodiments described herein may use an under-sampling technique for the portion of the transmitted signal to enable less data to be handled and to enable simple and current saving ADCs to be used.

The foregoing description of embodiments provides illustration and description, but is not intended to be exhaustive or to limit the invention to the precise form disclosed. Modifications and variations are possible in light of the above teachings or may be acquired from practice of the invention. For example, while a series of blocks has been described with regard to FIGS. 7-10, the order of the blocks may be modified in other embodiments. Further, non-dependent blocks may be performed in parallel.

It should be emphasized that the term “comprises/comprising” when used in this specification is taken to specify the presence of stated features, integers, steps or components but does not preclude the presence or addition of one or more other features, integers, steps, components or groups thereof.

It will be apparent that exemplary embodiments, as described above, may be implemented in many different forms of software, firmware, and hardware in the embodiments illustrated in the figures. The actual software code or specialized control hardware used to implement these aspects should not be construed as limiting. Thus, the operation and behavior of the aspects were described without reference to the specific software code. It being understood that software and control hardware could be designed to implement the aspects based on the description herein.

Further, certain portions of the invention may be implemented as “logic” that performs one or more functions. The logic may include hardware, such as an application specific integrated circuit, a field programmable gate array, a processor, or a microprocessor, or a combination of hardware and software.

Even though particular combinations of features are recited in the claims and/or disclosed in the specification, these combinations are not intended to limit the invention. In fact, many of these features may be combined in ways not specifically recited in the claims and/or disclosed in the specification.

No element, block, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A communication device, comprising:
a transmitter configured to provide a transmitted output signal; and
a power detector comprising an analog part and a digital part, where the analog part is configured to:
receive a portion of the transmitted output signal from the transmitter,
convert the portion of the transmitted output signal to baseband signals, and
convert each baseband signal to a digital representation of the portion of the transmitted output signal using an analog-to-digital converter,
and where the digital part is configured to:
receive reference signals from a waveform generator associated with the transmitter,
compare the reference signals with the digital representation,
calculate a gain associated with the transmitter based on the comparison,
receive, from the waveform generator, a root mean square (RMS) value of the reference signals, and
generate an estimate of the output power of the transmitter based on the calculated gain and the root mean square (RMS) value of the reference signals.

2. The communication device of claim 1, where the power detector is further configured to:
control the output power of the transmitter based on the estimate of the output power.

3. The communication device of claim 1, where the sample rate of the analog-to-digital converter is less than two times an information bandwidth associated with the portion of the transmitted output signal.

4. The communication device of claim 1, where, when comparing the reference signals with the digital representation, the power detector is further configured to:
apply a direct current (DC) compensation process to the comparison between the reference signals and the digital representation.

5. The communication device of claim 1, where, when comparing the reference signals with the digital representation, the power detector is further configured to:
apply a time alignment process to compensate for delay and to enable the comparison between the reference signals and the digital representation.

6. The communication device of claim 5, where, when applying the time alignment process, the power detector is further configured to at least one of:
apply a coarse time alignment process to the comparison between the reference signals and the digital representation,
apply a fine time alignment process to the comparison between the reference signals and the digital representation, or
apply an interpolation process to the comparison between the reference signals and the digital representation.

7. The communication device of claim 5, where, when comparing the reference signals with the digital representation, the power detector is further configured to:
apply a distortion reduction process to the comparison between the reference signals and the digital representation.

8. The communication device of claim 1, where, when calculating a gain associated with the transmitter based on the comparison, the power detector is further configured to:
divide a mean value of an envelope associated with the digital representation by a mean value of an envelope associated with the reference signals to calculate the gain.

9. The communication device of claim 1, where, when calculating a gain associated with the transmitter based on the comparison, the power detector is further configured to:
calculate a root mean square (RMS) value of an envelope associated with the digital representation,
calculate a root mean square (RMS) value of an envelope associated with the reference signals, and
divide the root mean square (RMS) value of the envelope associated with the digital representation by the root mean square (RMS) value of the envelope associated with the reference signals to calculate the gain.

10. The communication device of claim 1, where the communication device comprises one or more of:
a radiotelephone;
a personal communications system (PCS) terminal that combines a cellular radiotelephone with data processing and data communications capabilities; or
a personal digital assistant (PDA).

11. The communication device of claim 1, where the analog part of the power detector comprises:
a variable gain amplifier configured to:
receive the portion of the transmitted output signal from the transmitter, and
buffer the portion of the transmitted output signal;
a mixer configured to:
receive the portion of the transmitted output signal from the variable gain amplifier, and
convert the portion of the transmitted output signal from a radio frequency signal to a baseband signal; and
the analog-to-digital converter configured to:
receive the baseband signals from the mixer, and
convert the baseband signals from analog signals into digital signals.

12. A method, performed by a communication device that includes an analog-to-digital converter, a transmitter, and a waveform generator associated with the transmitter, the method comprising:
receiving reference signals from the waveform generator;
receiving, from the transmitter, a portion of a transmitted output signal;
converting the portion of the transmitted output signal to a digital representation in the analog-to-digital converter;
comparing the reference signals with the digital representation of the portion of the transmitted output signal;
calculating a gain associated with the transmitter based on the comparison;
receiving, from the waveform generator, a root mean square (RMS) value of reference signals; and
providing an estimate of the output power of the transmitter based on the calculated gain and the root mean square (RMS) value of the reference signals.

13. The method of claim 12, further comprising:
controlling the output power of the transmitter based on the estimate of the output power.

14. The method of claim 12, where a sample rate of the analog-to-digital converter is less than two times an information bandwidth associated with the portion of the transmitted output signal.

15. The method of claim 12, where comparing the reference signals with the digital representation of the portion of the transmitted output signal comprises:
applying a direct current (DC) compensation process to the comparison between the reference signals and the digital representation of the portion of the transmitted output signal.

16. The method of claim 12, where comparing the reference signals with the digital representation of the portion of the transmitted output signal comprises:
applying a time alignment process to compensate for delay and to enable the comparison between the reference signals and the digital representation of the portion of the transmitted output signal.

17. The method of claim 16, where applying a time alignment process comprises at least one of:
applying a coarse time alignment process to the comparison between the reference signals and the digital representation of the portion of the transmitted output signal;
applying a fine time alignment process to the comparison between the reference signals and the digital representation of the portion of the transmitted output signal; or
applying an interpolation process to the comparison between the reference signals and the digital representation of the portion of the transmitted output signal.

18. The method of claim 12, where comparing the reference signals with the digital representation of the portion of the transmitted output signal comprises:
applying a distortion reduction process to the comparison between the reference signals and the digital representation of the portion of the transmitted output signal;

19. The method of claim 12, where calculating a gain comprises:
dividing a mean of an envelope associated with the digital representation of the portion of the transmitted output signal by a mean of an envelope associated with the reference signals to calculate the gain.

20. The method of claim 11, where calculating a gain comprises:
calculating a root mean square (RMS) value of an envelope associated with the digital representation of the portion of the transmitted output signal;
calculating a root mean square (RMS) value of an envelope associated with the reference signals; and
dividing the root mean square (RMS) value of the envelope associated with the digital representation of the portion of the transmitted output signal by the root mean square (RMS) value of the envelope associated with the reference signals to calculate the gain.

21. The method of claim 11, where the communication device comprises one or more of:
a radiotelephone;
a personal communications system (PCS) terminal that combines a cellular radiotelephone with data processing and data communications capabilities; or
a personal digital assistant (PDA).

22. A communication device, comprising:
a memory to store a plurality of instructions; and
a processor to execute instructions in the memory to:
receive reference signals from a transmitter associated with the communication device,
receive, from the transmitter, a portion of a transmitted output signal,
compare the reference signals with a digital representation of the portion of the transmitted output signal,
calculate a gain associated with the transmitter based on the comparison,
receive, from a waveform generator associated with the transmitter, a root mean square (RMS) value of the reference signals,
provide an estimate of the output power of the transmitter based on the calculated gain and the root mean square (RMS) value of the reference signals, and
control the output power of the transmitter based on the estimate of the output power.

23. The communication device of claim 22, where, when comparing the reference signals with the digital representation of the portion of the transmitted output signal, the processor further executes instructions in the memory to at least one of:
apply a direct current (DC) compensation process to the comparison between the reference signals and the digital representation of the portion of the transmitted output signal
apply a coarse time alignment process to the comparison between the reference signals and the digital representation of the portion of the transmitted output signal,
apply a fine time alignment process to the comparison between the reference signals and the digital representation of the portion of the transmitted output signal,
apply an interpolation process to the comparison between the reference signals and the digital representation of the portion of the transmitted output signal, or
apply a distortion reduction process to the comparison between the reference signals and the digital representation of the portion of the transmitted output signal.

24. The communication device of claim 22, where, when calculating a gain, the processor further executes instructions in the memory to:
divide a mean value of an envelope associated with the digital representation of the portion of the transmitted output signal by a mean value of an envelope associated with the reference signals to calculate the gain.

25. The communication device of claim 22, where, when calculating a gain, the processor further executes instructions in the memory to:
calculate a root mean square (RMS) value of an envelope associated with the digital representation of the portion of the transmitted output signal,
calculate a root mean square (RMS) value of an envelope associated with the reference signals, and
divide the root mean square (RMS) value of the envelope associated with the digital representation of the portion of the transmitted output signal by the root mean square (RMS) value of the envelope associated with the reference signals to calculate the gain.
